(19) United States
(12) Patent Application Publication
(10) Pub. No.: US 2004/0176546 A1
(43) Pub. Date: Sep. 9, 2004

(54) Secondary coatings and fiber glass strands having a secondary coating

(76) Inventor: Robert W. Greer IV, Lexington, NC (US)

Correspondence Address: J. Jason Link, Esq., Kilpatrick Stockton LLP, 1001 West Fourth Street, Winston-Salem, NC, 27101-2410, US

(21) Appl. No.: 10/754,944

(22) Filed: Jan. 9, 2004

Related U.S. Application Data
(60) Provisional application No. 60/439,129, filed on Jan. 10, 2003.

(51) Int. Cl. C08G 18/00

(52) U.S. Cl. 525/452; 528/44

(57) ABSTRACT

The present invention relates to secondary coating compositions for glass fibers, glass fibers at least partially coated with the residue of a secondary coating composition, and cable assemblies comprising glass fibers at least partially coated with the residue of a secondary coating composition. A secondary coating composition can comprise a polyurethane and a wax. A secondary coating composition can further comprise a cross-linking agent. A cable assembly can comprise a conductor, a protective layer, and glass fibers at least partially coated with the residue of a secondary coating.

### CROSS REFERENCE TO RELATED APPLICATION

This application claims priority to, and incorporates by reference in full, the following co-pending application of Applicant: U.S. Provisional Patent Application No. 60/439,129, filed Jan. 10, 2003, entitled “Secondary Coatings and Fiber Glass Strands Having a Secondary Coating.”

### FIELD OF THE INVENTION

The present invention relates generally to secondary coatings for fiber glass strands and to improved fiber glass products having secondary coatings.

### BACKGROUND OF THE INVENTION

Fiber glass strands can be used in a number of different applications. For example, fiber glass strands can be used for aerial drop wire cable reinforcement or for fiber optic cable reinforcement in the telecommunications industry. Aerial drop wire cables are used in the telecommunications industry to connect a customer to a communications service. For example, aerial drop wire cables are typically utilized in the telecommunications industry to connect primary or secondary communications lines to their end users to provide services such as telephone, Internet, or cable TV. Drop wire cables typically include an insulated wire or wires surrounded by a PVC jacket. The wire (or plurality of wires) is typically a conductor, such as copper or copper-plated steel. Other components of the cable may include a polyester or Kevlar™ rip cord for breakout and splicing access, a water-blocking tape or powder, and fiber glass. Fiber glass strands may be used as reinforcement in the drop wire cable. In these applications, strands of coated fiber glass (typically, two to eight) are co-extruded as reinforcement members in a drop wire cable. The coated fiber glass strands are useful as they become the load-bearing member of the cable.

Problems that may arise in processing fiber glass strands in drop wire cable reinforcement applications include blistering and “breakouts” during processing. These problems may arise more frequently as the line speed increases during manufacture of the cable (i.e., the rate at which the fiber glass is co-extruded with the thermoplastic material that forms a jacket). Higher line speeds reduce the amount of time to evaporate moisture in the pre-heater system that functions to raise the temperature of the surface of the fiber glass strand to compatibilize the material with the thermoplastic material (e.g., polyvinyl chloride) used to form the cable's jacket, and to remove moisture from the surface of the strand. As used herein, the term “blister” refers to a bump in the cable jacket that appears during co-extrusion of the fiber glass strand into the thermoplastic material. As used herein, the term “breakout” refers to a break in a fiber glass strand as it is paid out from its package. Breakouts interrupt the co-extrusion process and cause delays. Breakouts often occur when the strand-to-strand adhesion in the wound package being paid out and the friction due to payout exceed the strength of the glass.

It would be desirable to have fiber glass strands that perform well in drop wire reinforcement applications by exhibiting reduced blistering and fewer breakouts during processing while maintaining strong adhesion to the jacket material (e.g., polyvinyl chloride).

### SUMMARY

In accordance with the present invention, there is provided a secondary coating composition for fiber glass products. Also provided are fiber glass products having a secondary coating composition and cable assemblies, such as drop wire cable assemblies, including fiber glass strands of the present invention.

The secondary coating can advantageously allow the fiber glass strands to tolerate higher drying temperatures and to be processed at higher line speeds when co-extruded with an insulating jacket in cable applications without an increase in breakouts and without increased blistering.

In one embodiment, a secondary coating composition for at least partially coating glass fibers comprises a polyurethane in an amount greater than about 85 weight percent of the secondary coating composition based on total solids and a wax. In a further embodiment, the polyurethane is present in an amount greater than about 90 weight percent of the secondary coating composition based on total solids. The secondary coating composition, in one non-limiting embodiment, further comprises a cross-linking agent.

In another embodiment, the major constituents of a secondary coating composition for at least partially coating glass fibers include a polyurethane in an amount greater than about 85 weight percent of the secondary coating composition based on total solids and a wax. In a further embodiment, the polyurethane is present in an amount greater than about 90 weight percent of the secondary coating composition based on total solids.

The major constituents of a secondary coating composition for at least partially coating glass fibers, in another embodiment, include a polyurethane in an amount greater than about 85 weight percent of the secondary coating composition based on total solids, a wax, and a cross-linking agent. In a further embodiment, the polyurethane is present in an amount greater than about 90 weight percent of the secondary coating composition based on total solids.

Polyurethanes useful in embodiments of the present invention comprise thermally stable polyurethanes. In some embodiments, the polyurethane does not degrade until temperatures of 220° C. or greater after one minute in an air environment. The polyurethane, in other embodiments, may be substantially free of unreacted hydroscopic polyol segments. In other embodiments, the polyurethane may be substantially free of unreacted hydrophilic polyol segments.

In embodiments of the present invention, the wax can comprise polyethylene. In other embodiments, the wax can comprise polypropylene. The wax can be present in an amount up to about 15 weight percent of the secondary coating composition based on total solids in some embodiments. The wax can be present, in other embodiments, in an amount up to about 10 weight percent of the secondary coating composition based on total solids. In other embodiments, the wax can be present in an amount up to about 8 weight percent of the secondary coating composition based on total solids.

In embodiments utilizing a cross-linking agent, the cross-linking agent can comprise an acid, an amine, or an epoxy. The cross-linking agent, in some embodiments, can be present in amount up to about 5 weight percent of the secondary coating composition based on total solids. In other embodiments, the cross-linking agent can be present in amount up to about 2 weight percent of the secondary coating composition based on total solids.

Embodiments of the present invention are also directed to glass fibers at least partially coated with the residue of a secondary coating composition of the present invention. In embodiments directed to a plurality of glass fibers, the glass fibers can have a loss on ignition of up to twenty weight percent. In other embodiments, the glass fibers can have a loss on ignition of between about three and about fifteen weight percent. The glass fibers, in further embodiments, can have a loss on ignition of between about nine and about eleven and one-half weight percent.

The present invention also relates to fiber glass strands adapted to exhibit reduced blistering and fewer breakouts during co-extrusion. A fiber glass strand, in one embodiment, comprises at least one glass fiber at least partially coated with a secondary coating composition. The major constituent, in one embodiment, can include a polyurethane in an amount greater than about 85 weight percent on a total solids basis and a wax. In another embodiment, the major constituents can comprise a polyurethane in an amount greater than about 85 weight percent on a total solids basis, a wax, and a cross linker. Embodiments of the present invention also relate to cable assemblies that comprise at least one of such fiber glass strands.

In other embodiments, cable assemblies of the present invention comprise a conductor, a protective layer positioned about at least a portion of a periphery of the conductor, and glass fibers at least partially coated with the residue of a secondary coating composition of the present invention. The protective layer, in some embodiments, can comprise polyvinyl chloride.

These and other embodiments of the present invention are described in greater detail in the detailed description of the invention which follows.

### BRIEF DESCRIPTION OF THE FIGURES

FIG. 1 is a cross-sectional view of a non-limiting embodiment of a cable assembly including coated strands according to the present invention.

FIG. 2 is a cross-sectional view of another non-limiting embodiment of a cable assembly including coated strands according to the present invention.

### DETAILED DESCRIPTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

The present invention relates to new secondary coating compositions for fiber glass. In non-limiting embodiments, the secondary coating compositions are particularly useful on fiber glass to be used in cable assemblies, such as drop wire cable applications. Other non-limiting embodiments of the present invention relate to glass fiber and fiber glass strands coated with secondary coating compositions. The present invention also relates to cable assemblies incorporating fiber glass strands coated with secondary coating compositions.

The present invention will be discussed generally in the context of its use in the production, assembly, and application of glass fibers. However, one of ordinary skill in the art would understand that the present invention may be useful in the processing of other textile materials.

Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as “E-glass”, “A-glass”, “C-glass”, “S-glass”, “ECR-glass” (corrosion resistant glass), and fluorine and/or boron-free derivatives thereof. Typical formulations of glass fibers are disclosed in K. Loewenstein, The Manufacturing Technology of Continuous Glass Fibres, (3d Ed. 1993). The present invention is particularly useful in the production, assembly, and application of glass fibers prepared from E-glass compositions.

Glass fibers are produced by flowing molten glass via gravity through a multitude of small openings in a precious metal device, called a bushing. After the fibers have cooled very shortly after their issuance from the bushing and usually in close proximity to the bushing, these fibers are treated with a chemical treating formulation usually referred to in the art as a sizing composition, sizing, size, binder composition, or binder. As used herein, the term “sizing composition” refers to the aqueous composition applied to the fibers immediately after formation of the fibers, which is preferably subsequently dried. The sizing composition serves to make the fibers more compatible with the material they will ultimately be used to reinforce and/or to make the fibers easier to process. The sizing composition can be applied by sprayers, rollers, belts, metering devices, or other similar application devices. The sized glass fibers are gathered into bundles or strands comprising a plurality of individual fibers, generally from 200 to more than 4000. The sized glass fibers generally can have between 0.01 and 5 percent of sizing composition based on the weight of the glass fiber.

After their formation and treatment, the strands are typically wound on a spool or “forming package.” The strands can be wound onto a paper or plastic tube, for example, using a high speed winder. High speed winders, in one non-limiting embodiment, comprise winders that can wind at speeds up to 6,000 revolutions per minute. Examples of such winders useful in the present invention are commercially available from Shimadzu Corporation of Japan and from Deitz and Schell of Germany.

The strands can also be wound directly on the winder as a direct process package. As used herein, “direct process” package refers to a wound package of continuously drawn fiber glass strand that is wound with substantially no twist and in such a way as to produce a package with square ends utilizing a winder that has a cam that guides the strand back and forth at high speed onto the package resulting in a “waywind” or wind ratio. A fiber glass strand with “substantially no twist” refer to strands that have not been twisted after being wound on a package. It should be noted that there is some twist in a fiber glass strand in a direct process package that results when fiber glass strands are formed and wound into a package. In addition, there can be additional “incidental twist” in the fiber glass strand as it is paid out from the direct process package. Thus, fiber glass strands with substantially no twist can have some twist in them due to formation and winding and/or due to pay out from the direct process package. The forming or direct process packages are usually dried in either an oven or at room temperature to remove some of the moisture from the fibers. Additional information related to fiberizable glass compositions and methods of making glass filaments are disclosed in K. Loewenstein, The Manufacturing Technology of Glass Fibres, (3d Ed. 1993) at pages 30-44, 47-60, 115-122 and 126-135, which are hereby incorporated by reference.

In one non-limiting method for preparing a fiber glass strand of the present invention, a strand is paid out through tensioners from a forming package or direct process package (a plurality of strands may be paid out from a plurality of such packages or multiple strands may be paid out from a single package). The fiber glass strand is then coated with a secondary coating composition. As used herein, the term “secondary coating composition” refers to a composition applied secondarily, after an initial sizing composition has been applied. The secondary coating composition may be conventionally applied by dipping the strand in a bath containing the composition, by spraying the secondary coating upon the strand or by contacting the strand with a static or dynamic applicator such as a roller or belt applicator, for example. The coated strand may be passed through a die to remove excess coating composition from the strand and/or dried for a time sufficient to at least partially dry or cure the secondary coating composition.

The secondary coating composition is typically applied to the strands by passing the strands through a bath or dip of the secondary coating composition and exposing the fibers to elevated temperatures for a time sufficient to at least partially dry or cure the secondary coating composition. In some non-limiting embodiments, the strand can be “opened up” just before entering the secondary coating bath by passing it over a bar or other spreading device which acts to separate the individual fibers from one another. This spreading of the fibers from one another may result in a more thorough impregnation of the strand with the secondary coating composition.

A fixed orifice die is then used to remove the excess coating. The die strips off excess secondary coating composition and controls the amount of secondary coating composition on the strand as the glass and the secondary coating composition are effectively incompressible inputs. In other words, because the fiber glass strand and the secondary coating composition are effectively not compressible, the die is able to control the amount of secondary coating composition on the strand. For example, the amount of secondary coating composition on the fiber glass strand may be increased by increasing the diameter of the die, by decreasing the size of the fiber glass strand, and/or by decreasing the amount of water in the secondary coating composition.

Another method of adding the secondary coating to the fiberglass strand is to use kiss rolls to apply the coating before passing the coated strand into the oven for drying. The amount of coating can be controlled through the solids content of the coating composition, the speed of the applicator rolls, and the number of rolls.

The amount of sizing composition, secondary coating composition, or sizing composition and secondary coating composition on the strand may be measured as “loss on ignition” or “LOI”. As used herein, the term “loss on ignition” or “LOI” means the weight percent of dried coating (sizing composition and/or secondary coating composition) present on the fiber glass as determined by Equation 1:

LOI=100×[(W_{dry}−W_{bare})/W_{dry}] (Eq. 1)

wherein W_{dry} is the weight of the fiber glass plus the weight of the coating after drying in an oven at 220° F. (about 104° C.) for 60 minutes, and W_{bare} is the weight of the bare fiber glass after heating the fiber glass in an oven at 1150° F. (about 621° C.) for 20 minutes and cooling to room temperature in a dessicator.

Depending on when it is measured, LOI may refer to the amount of sizing composition on a fiber glass strand, the amount of secondary coating composition on a fiber glass strand, or the amount of sizing composition and secondary coating composition on the fiber glass strand. For example, if LOI is measured before the fiber glass strand is wound, then LOI refers to the amount of sizing composition on the strand. If the LOI is measured after dipping in a secondary coating composition and drying the coated strand, LOI refers to the amount of sizing composition and secondary coating composition on the strand. If the LOI is measured at each of the previous locations, the difference between the LOI after dipping and drying and the LOI prior to winding will provide the amount of secondary coating composition on the strand.

In general, although not limiting, the loss on ignition (LOI) of the fiber glass strand may be less than 15 weight percent when the LOI is measured after the sizing composition and the secondary coating composition are applied. In other non-limiting embodiments, the LOI may be between 0.1 and 15 weight percent. In further non-limiting embodiments, the LOI may be between 3 and 15 weight percent. In still further non-limiting embodiments, the LOI may be between 9 and 11.5 weight percent.

The strand is preferably dried after application of the secondary coating composition in a manner well known in the art. The impregnated strand is at least partially dried in air at room temperature (about 25° C.) or alternatively in a furnace or oven preferably above 232° C. (450° F.) to speed the curing process and evaporate the water. A particularly suitable dryer is that disclosed in U.S. Pat. No. 5,197,202, which is hereby incorporated by reference.

After drying, the strand may be wound up using a conventional fiberglass roving winder. An example of a roving winder useful in the present invention is model number 959, commercially available from Leesona of Burlington, N.C. In one non-limiting embodiment using this roving winder, the strand may be wound up using a “way wind ratio” from 1-10, meaning that the package goes through ten circular rotations for each single traverse pass across the package. Other devices known to those of ordinary skill in the art can also be used to wind up the coated strands. Examples of such devices include model number 967 from Leesona, roving winders from Deitz and Schell of Germany, and turreting roving winders from SAHM, Inc.

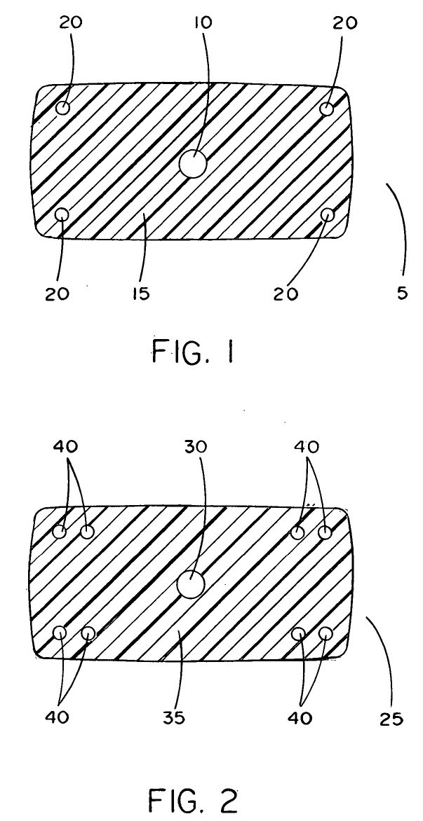

The coated strand can be incorporated as reinforcement in a cable assembly as shown and discussed below with regard to FIGS. 1 and 2. For example, a manufacturer of drop wire cable may pay out coated strands from the roving packages and co-extrude the strands into drop wire cable utilizing a continuous process. In other non-limiting embodiments, the coated strand can be incorporated in optical cable applications.

The present invention relates to secondary coating compositions, coated fiber glass strands, and drop wire cable assemblies. Secondary coating compositions of the present invention can comprise a polyurethane and a wax. In some embodiments, the secondary coating composition can further comprise a cross-linking agent.

In one embodiment, a secondary coating composition for at least partially coating glass fibers comprises a polyurethane in an amount greater than about 85 weight percent of the secondary coating composition based on total solids and a wax. In a further embodiment, the polyurethane can be present in an amount greater than about 90 weight percent of the secondary coating composition based on total solids. The secondary coating composition, in one non-limiting embodiment, can further comprise a cross-linking agent.

In embodiments, the major constituents of a secondary coating composition for at least partially coating glass fibers include a polyurethane in an amount greater than about 85 weight percent of the secondary coating composition based on total solids and a wax. In a further embodiment, the polyurethane can be present in an amount greater than about 90 weight percent of the secondary coating composition based on total solids.

The major constituents of a secondary coating composition for at least partially coating glass fibers, in other embodiments, include a polyurethane in an amount greater than about 85 weight percent of the secondary coating composition based on total solids, a wax, and a cross-linking agent. In a further embodiment, the polyurethane can be present in an amount greater than about 90 weight percent of the secondary coating composition based on total solids.

As used herein, the term “major constituents” refers to the primary components of the composition, other than water. When the term “major constituents” is used in connection with a secondary coating composition, it is not meant to limit the constituents of the secondary coating composition to only the constituents listed as major constituents. Rather, the secondary coating composition can include other constituents, so long as those constituents are not present in amounts that would substantially affect the properties provided by the major constituents, or combination of the major constituents, when the secondary coating composition is applied to a carrier, such as a fiber glass strand. Examples of such additional constituents can include, without limitation, stabilizers, anti-oxidants, pigments or other colorants, PVC plasticizers, and surfactants.

Suitable polyurethanes for use in the secondary coating composition can include any emulsifiable thermoplastic urethane, such as elastomeric, cross-linkable polyurethanes. In general, suitable polyurethanes for use in the present invention can include any polyester-, any polyether-, or any polyester/polyether-based aliphatic or aromatic water-based polyurethanes that can produce a low-tack or tack-free strand with limited wax or other slip agent. Low-tack or tack-free strands can be unwound or paid out from packages at speeds as high as 600 feet per minute with a low level of breaks (i.e., without significant interruptions in processing due to breaks in the strand). For example, a strand that is too tacky can cause a break when the force required to unwind or pay out the strand from the package exceeds the tensile strength of the strand.

In selecting a polyurethane useful in the present invention, one important factor is the thermal stability of the polyurethane. In non-limiting embodiments, polyurethanes useful in the present invention do not degrade or depolymerize at relatively low temperatures. It is known to those skilled in the art that the urethane bond in a polyurethane can break at temperatures ranging from 180 to 220° C. and that degradation in polyurethanes can begin at temperatures between 100 and 220° C. Factors such as the atmospheric condition (oxygen concentration) and the time at a particular temperature can raise or lower the observed stability to above or below that range of temperatures. It is important, in non-limiting embodiments of the present invention, to utilize polyurethanes that are thermally stable, such that the polyurethanes can withstand the processing temperatures associated with co-extrusion with a thermoplastic material. The degradation of polyurethanes during co-extrusion, for example, can generate volatile byproducts that can lead to blisters.

In one non-limiting embodiment, polyurethanes desirable for use in the present invention may not degrade until temperatures of greater than 220° C. after one minute in an air environment. As used herein, a polyurethane “degrades” when a gravimetric weight loss of greater than 2%, as determined by a standard thermogravimetric analyzer (TGA), is observed and/or when a substantial color change is observed.

Other factors may also be important in selecting polyurethanes for use in the present invention. Desirable polyurethanes for the present invention may be substantially free of unreacted hydroscopic polyol segments and/or may be substantially free of unreacted water soluble (hydrophilic) polyol segments. Aqueous polyurethane dispersions useful in non-limiting embodiments of the present invention may have a percent solids greater than 20 weight percent. Polyurethanes useful in embodiments of the present invention should be compatible with the thermoplastic material with which it will be co-extruded. For example, if a fiber glass strand coated with a secondary coating composition of the present invention is to be co-extruded with polyvinylchloride, then the polyurethane in the coating composition can assist the strand in adhering to the PVC at the speeds and temperatures associated with co-extrusion.

Non-limiting examples of polyurethanes useful in secondary coating compositions of the present invention include aqueous dispersions of polyurethane, such as WITCOBOND W-290H and WITCOBOND W-296, both of which are commercially available from Crompton Corporation-Uniroyal Chemical, and Aquathane 516, available from Reichhold Chemical Company. Other useful aqueous dispersions of polyurethane include Hydrosize U2-01, commercially available from Hydrosize Technologies, Inc. of Raleigh, N.C.

In one non-limiting embodiment, polyurethane can be present in an amount greater than about fifty (50) weight percent of the secondary coating composition based on total solids. In another non-limiting embodiment, polyurethane can be present in an amount greater than about eighty-five (85) weight percent of the secondary coating composition based on total solids. In a further embodiment, polyurethane can be present in an amount greater than about ninety (90) weight percent of the secondary coating composition based on total solids.

Embodiments of secondary coating compositions of the present invention may further comprise a wax. The wax can function as an anti-blocking or release agent. The wax can counterbalance the natural tackiness of polyurethane and result in a fiber glass strand coated with the secondary coating composition that is low-tack or tack-free. Waxes desirable for use in the present invention should be dispersible in water. Some waxes may be dispersible in water without modification while others may need to be functionalized. In one non-limiting embodiment, to add a wax to a secondary coating composition, the wax can be functionalized by reacting the wax with maleic anhydride or by oxidizing the wax with hot air to produce polar groups. Waxes useful in embodiments of the present invention can be functionalized in other ways known to those of skill in the art. Examples of waxes suitable in embodiments of the present invention can include petroleum waxes, such as polyethylene wax and polypropylene wax. Instead of waxes, other non-limiting embodiments of the present invention might comprise silicone-based materials, or materials based on polypropylene or polytetrafluoroethylene.

Non-limiting examples of polyethylene waxes useful in secondary coating compositions of the present invention include aqueous dispersions of functionalized polyethylene wax, such as PETROLITE 75 microcrystalline wax, which is commercially available from Baker Petrolite, Polymers Division, of Sugar Land, Tex. Other anionic, non-ionic, or cationic aqueous dispersions of polyethylene wax, polypropylene wax, or other formulations useful in embodiments of the present invention include Protolube HDA, which is commercially available from Bayer AG; Hydrocer D336, Hydrocer 257, and Hydrocer EP91, which are commercially available from Shamrock Technologies of Newark, N.J.; Hydrosize PE1-01 from Hydrosize Technologies of Raleigh, N.C.; and Abcolene H-35, Abcolene H-22, and Lubril HS-60, which are commercially available from ABCO. Non-limiting examples of other materials that might be used in embodiments of the present invention may include Polymeekon SPP-W, which is commercially available from Bayer AG; Aquaslip 671, Aquaslip 622, Aquaslip 670, Aquaslip 658, Lanco Glidd FW6215, Lanco Glidd FW6445, and Lanco Glidd FW3540, which are commercially available from Lubrizol Corporation; Fluoro AQ-50, which is commercially available from Shamrock Technologies of Newark, N.J.; ME72040, ME32535, ME39235, ME93235, MTU200, ME99235, MGLD37, ME21635, and ME29235, which are commercially available from Michelman; Velvetol 77-19 and Velvetol 77-47, which are commercially available from ABCO; and 43N40, 43A40, 540N30, 597N40, WE4-25A, and PP25, which are commercially available from ChemCorps.

In one non-limiting embodiment, wax can be present in an amount up to about fifteen (15) weight percent of the secondary coating composition based on total solids. In another non-limiting embodiment, wax can be present in an amount up to about ten (10) weight percent of the secondary coating composition based on total solids. In a further embodiment, wax can be present in an amount between about three (3) and about eight (8) weight percent of the secondary coating composition based on total solids.

In some non-limiting embodiments, the secondary coating composition may further comprise a cross-linking agent. The cross-linking agent may assist in the cross-linking of the aqueous urethane or polyurethane dispersions. Non-limiting examples of suitable cross-linking agents useful in secondary coating compositions of the present invention include multi-functional acid cross-linking agents, multi-functional amine cross-linking agents, or multi-functional epoxy cross-linking agents. “Multi-functional”, when referring to such cross-linking agents, means that the cross-linking agent comprises at least two functional groups (e.g., at least two acid groups, at least two amine groups, or at least two epoxy groups) that allow the cross-linking agent to react with more than one polyurethane chain. In one non-limiting embodiment, the cross-linking agent can comprise an epoxy cross-linking agent. An example of an epoxy cross-linking agent useful in embodiments of the present invention is WITCOBOND XW, which is commercially available from Crompton Corporation-Uniroyal Chemical.

One factor in deciding whether to include a cross-linking agent in the secondary coating composition is the polyurethane dispersion that is used. For example, WITCOBOND W-296 is a polyurethane dispersion with a “built in,” co-polymerized cross-linking agent. Polyurethanes with a built-in, co-polymerized cross-linking agent, and polyurethanes that self-cross-link, can be more desirable than polyurethanes that require the addition of a separate cross-linking agent. For example, if a separate cross-linking agent is not fully used during cure (e.g., some cross-linking agent remains unreacted in the dispersion), the remaining cross-linking agent might volatilize when a coated strand is co-extruded with a thermoplastic material. While cross-linking may be necessary for some polyurethanes to be used in embodiments of the present invention, reducing the likelihood of volatilization by any cross-linking agent during co-extrusion, in some non-limiting embodiments, can make the process more robust, particularly if the secondary coating composition is incompletely cured due to a process upset.

When WITCOBOND W-296 is utilized, it may not be necessary to include a cross-linking agent in the secondary coating composition. On the other hand, WITCOBOND W-290H and Aquathane D516 do not include built-in cross-linking agents, such that it may be desirable to include a cross-linking agent in the secondary coating composition. WITCOBOND XW cross-linking agent is compatible with each of these polyurethane dispersions.

In embodiments of the present invention utilizing a cross-linking agent in the secondary coating composition, the cross-linking agent can be present in an amount up to about fifteen (15) weight percent of the secondary coating composition based on total solids. In another non-limiting embodiment, the cross-linking agent can be present in an amount up to about five (5) weight percent of the secondary coating composition based on total solids. In a further embodiment, the cross-linking agent can be present in amount up to about two (2) weight percent of the secondary coating composition based on total solids.

Other ingredients of the secondary coating composition can include, without limitation, stabilizers, anti-oxidants, pigments or other colorants, PVC plasticizers, and surfactants.

The present invention also relates to fiber glass strands coated with secondary coating compositions of the present invention. The fiber glass strands may be coated with the secondary coating composition, as discussed above, by dipping the strand in a bath containing the composition, by spraying the secondary coating upon the strand or by contacting the strand with a static or dynamic applicator such as a roller or belt applicator, for example. The secondary coating composition is preferably applied to the strands by passing the strands through a bath or dip of the secondary coating composition. The coated strand may then be passed through a die to remove excess coating composition from the strand and dried for a time sufficient to at least partially dry or cure the secondary coating composition.

Non-limiting embodiments of coated fiber glass strands of the present invention may comprise a fiber glass strand and a secondary coating composition. The number of filaments and the diameters of filaments used to form coated fiber glass strands can vary depending on the desired application.

In one non-limiting embodiment, a coated fiber glass strand of the present invention can comprise between twenty (20) and ten thousand (10,000) filaments per strand. In another non-limiting embodiment, a coated fiber glass strand of the present invention can comprise between two thousand (2000) and four thousand five hundred (4,500) filaments per strand. The strands, in non-limiting examples, can be from fifty yards per pound to more than one thousand yards per pound depending on the application.

The diameter of the filaments used in non-limiting embodiments of coated strands of the present invention may, in general, be between five (5) and eighty (80) microns. In another non-limiting embodiment, the diameter of the filaments may be between ten (10) and eighteen (18) microns. In one non-limiting embodiment of a fiber glass strand comprising 4000 filaments, the average diameter of each filament may be between twelve (12) and seventeen (17) microns.

In embodiments of the present invention where the coated fiber glass strand is to be used as reinforcement for drop wire cable, one non-limiting embodiment of a coated strand comprises 2200 filaments, each filament having a 13.5 microns nominal diameter. In another non-limiting embodiment, a coated strand of the present invention comprises 4400 filaments, each filament having a diameter of 13.5 microns nominal diameter. A coated strand in another non-limiting embodiment comprises 4000 filaments, each filament having a diameter of 15.9 microns nominal.

In producing fiber glass strands of the present invention, an aqueous sizing composition is applied to the fibers after the issuance of the fibers from the bushing and usually in close proximity to the bushing.

The sizing composition serves to make the fibers more compatible with the material they will ultimately reinforce and/or to make the fibers easier to process. A number of sizing compositions known to those of ordinary skill in the art may be applied to fiber glass strands that will subsequently be coated with a secondary coating composition of the present invention for use in cable assemblies, such as drop wire cable or optical fiber applications. Examples include starch-oil type sizing compositions common for textile fiberglass and sizing compositions commonly used in reinforced product (RP) applications. A person of ordinary skill in the art will recognize that to achieve optimal wet-out and compatibility with the secondary coating composition, one should consider manufacturing the glass and sizing composition with as similar chemistry as possible to the secondary coating composition. For example, if the secondary coating composition's dominant component is a polyester polyol based polyurethane, then one should consider selecting a sizing composition that has a similar component in its formulation.

One example of a sizing composition suitable for use with a secondary composition of the present invention may comprise amino-functionalized silane, surfactant, lubricant, epoxy film formers, polyester resin film former, and defoamers. In general, the sizing composition should be of a similar chemical nature to the secondary coating (for chemical compatibility) and should not physically prevent penetration of the secondary coating into the center of the fiberglass bundle by binding the fiberglass filaments to one another.

After the sizing composition is applied, the glass fibers are dried and then wound. The fiber glass strands from the wound packages may subsequently be coated with a secondary coating composition of the present invention.

In non-limiting embodiments, coated fiber glass strands comprise a fiber glass strand and the residue of a secondary coating composition of the present invention, wherein the coated fiber glass strand may have a LOI of between 0.1 and twenty (20) weight percent. In another non-limiting embodiment, the coated fiber glass strand may have a LOI of greater than three (3) weight percent. In another non-limiting embodiment, the coated fiber glass strand may have a LOI of between three (3) and fifteen (15) weight percent. The coated fiber glass strand, in other embodiments, may have a LOI of between nine (9) and eleven and one-half (11.5) percent.

One non-limiting embodiment of a strand of the present invention comprises a plurality of fibers having on at least a portion of the surface thereof a residue of a secondary coating composition comprising a polyurethane and a wax. In a further embodiment, the secondary coating composition on at least a portion of the strand's surface further comprises a cross-linking agent.

The present invention also relates to cable assemblies, such as drop wire cable assemblies. In one non-limiting embodiment, a cable assembly of the present invention comprises a conductor, a protective layer positioned about at least a portion of a periphery of the conductor, and at least one fiber glass strand, wherein the strand comprises a plurality of fibers having on at least a portion of the surface thereof a residue of a secondary coating composition comprising a polyurethane and wax. In a further embodiment, the secondary coating composition on at least a portion of the strand's surface further comprises a cross-linking agent.

The conductor may be any conductive material used in cable applications, such as, for example, copper wire or copper-plated steel wire or a plurality of such wires.

The protective layer may comprise a thermoplastic material extruded as a jacket over the conductor and the at least one fiber glass strand. The protective layer protects the cable from damage from the environment. Suitable thermoplastic materials may include, for example, polyvinyl chloride (PVC). While PVC is the most common insulating jacket used in drop wire cable applications and optical fiber applications, secondary coating compositions of the present invention may also assist in adhesion to other insulating jackets, particularly those of made of materials similar to PVC.

In non-limiting embodiments of the present invention, at least one fiber glass strand is co-extruded with the protective layer. In one non-limiting embodiment, the cable assembly comprises between two (2) and twelve (12) fiber glass strands. In another non-limiting embodiment, the cable assembly may comprise between four (4) and eight (8) fiber glass strands. The fiber glass strands, in non-limiting embodiments, have the residue of a secondary coating composition of the present invention on at least a portion of the strands' surfaces.

FIG. 1 is a cross-sectional view of a non-limiting embodiment of a cable assembly 5 according to the present invention. The cable assembly 5 shown includes a conductor 10, a protective layer 15, such as polyvinyl chloride, and four coated fiber glass strands 20. The fiber glass strands 20 comprise a plurality of fibers having on at least a portion of the surfaces thereof the residue of a secondary coating composition comprising a polyurethane, a wax, and/or a cross-linking agent. The fiber glass strands 20, in the embodiment shown, are positioned near the “corners” of the drop wire cable assembly 5.

FIG. 2 is a cross-sectional view of another non-limiting embodiment of a cable assembly 25. In the embodiment shown, the cable assembly 25 includes a conductor 30, a protective layer 35, such as polyvinyl chloride, and eight coated fiber glass strands 40. The fiber glass strands 40 comprises a plurality of fibers having on at least a portion of the surfaces thereof the residue of a secondary coating composition comprising a polyurethane, a polyethylene wax, and/or a cross-linking agent. The fiber glass strands 40, in the embodiment shown, are positioned near the “corners” of the cable assembly 25.

In cable applications where polyvinyl chloride (PVC) is used as a protective layer, fiber glass strands coated with secondary coating compositions of the present invention exhibit strong adhesion to the PVC. In cable applications, the adhesion of the fiber glass strands to the PVC during co-extrusion is a very important factor in selecting a fiber glass strand to reinforce a cable assembly. Poor adhesion between the PVC and the fiber glass strands can cause failure of the cable due to the jacket sliding off of the strand and exposing the conductors, and can also cause the cable to sag if it is under tension.

One technique for measuring the adhesion of fiber glass strands to PVC is a static load test published by Telcordia Technologies Standard GR-1069 which is hereby incorporated by reference. Standard GR-1069 is entitled “Generic Requirements for Non-Metallic Reinforced Aerial Service Wire,” and may be ordered from Telcordia Technologies (http://telecom-info.telcordia.com/site-cgi/ido/index.html). As used herein, the term “drop wire” comprises aerial service wires. The static load test of Standard GR-1069 section 4.6.11 may be performed to determine PVC adhesion as a pass/fail criteria. In optical fiber applications, the cable tests are specified in Telcordia Technologies in Standard GR-20, which is hereby incorporated by reference. Standard GR-20 is entitled “Generic Requirements for Optical Fiber and Optical Fiber Cable,” and may be ordered from Telcordia Technologies. Some aerial drop cables contain optical fibers and those testing standards are specified in GR-20 along with several other cable designs for which this invention may function as a reinforcing member.

Fiber glass strands coated with secondary compositions of the present invention can provide acceptable adhesion to a PVC jacket in a drop wire cable assembly manufacturing process at higher processing speeds (and higher dryer temperatures) without any corresponding increase in blistering or breakouts. A “blister” is believed to be a result of outgassing of a liquid or solid substance (such as water, unreacted cross-linking agent, etc.) during co-extrusion of the fiberglass into the PVC jacket of the cable. In connection with development of the present invention, it was determined that blistering can be caused, at least in part, by incomplete drying. In particular, it was noted that moisture levels above 0.3% by weight can cause problems as the residual water can be a source for blistering during co-extrusion, which is typically performed at temperatures above 325° F. The present invention avoids this problem because the secondary coating can be dried at higher temperatures without the negative effects sometimes seen, such as the degradation of polyurethane.

A “breakout” may be caused by excessive tack near the center of the package that causes a payout failure. In other words, the strand-to-strand adhesion plus the friction due to payout exceeds the strength of the glass. A package may develop excessive tack due to a combination of incomplete curing of the secondary coating composition and the natural adhesion of wet fiberglass to itself.

The present invention will now be illustrated by the following specific, non-limiting examples.

### EXAMPLE 1

Fiber glass strands were supplied to a secondary coating process. The fiber glass strands were paid out from individual packages. In this example, the fiber glass strand was HYBON 2026 roving having a nominal filament diameter of thirteen microns, which is commercially available from PPG Industries, Inc. HYBON 2026 roving is a continuous filament, single-end roving designed to reinforce polyester, epoxy, and vinyl ester resin systems in pultrusion and filament winding applications. With a nominal filament diameter of thirteen microns, HYBON 2026 roving has a nominal yield of 675 yards per pound (+/−7%). HYBON 2026 is coated with a silane-based sizing composition at a nominal LOI of 0.70+/−7% based on the weight of the glass.

The fiber glass strands were paid out through tensioners and dipped in a secondary coating composition using techniques known to those of ordinary skill in the art. The secondary coating composition that was used is set forth in Table 1 below:

TABLE 1

| | Amount | % of |
|---|---|---|
| Component | (parts by weight) | solids |
| WITCOBOND W-296¹ | 450 lbs. | 97% |
| PETROLITE 75² | 21 lbs. | 3% |
| Water | 700 lbs. | 0% |

¹Polyurethane dispersion with built-in crosslinker from Crompton Corporation-Uniroyal Chemical.
²Functionalized polyethylene wax from Baker Petrolite, Polymer Division, of Cumming, Ga.

The ingredients in Table 1 were mixed together using a mixer to form a secondary coating composition. Each strand was then passed through a 0.050 inch die to remove excess coating composition from the strand. Each strand was then dried using a circulating air oven at 610° F. and wound using a conventional roving winder.

Coated fiber glass strands produced in the above manner performed well when co-extruded with polyvinyl chloride at 600 feet per minute to produce drop wire cable. These coated fiber glass strands passed the static load test (found in Standard GR-1069 from Telcordia Technologies). Further, the co-extruded PVC and fiber glass strands did not exhibit any unusual blistering or breakout problems during processing.

### EXAMPLE 2

In this example, the fiber glass strand was again HYBON 2026 roving having a nominal filament diameter of thirteen microns. This strand was provided to a secondary coating process.

The fiber glass strands were paid out through tensioners and dipped in a secondary coating composition using techniques known to those of ordinary skill in the art. The secondary coating composition that was used is set forth in Table 2 below:

TABLE 2

| | Amount | % of |
|---|---|---|
| Component | (parts by weight) | solids |
| WITCOBOND W-290H³ | 450 lbs. | 91.1 |
| PETROLITE 75⁴ | 22 lbs. | 3% |
| WITCOBOND XW⁵ | 32 lbs. | 5.9% |
| Water | 725 lbs. | 0% |

³Polyurethane dispersion from Crompton Corporation-Uniroyal Chemical.
⁴Functionalized polyethylene wax from Baker Petrolite, Polymer Division, of Cumming, Ga.
⁵Epoxy crosslinker from Crompton Corporation-Uniroyal Chemical.

The ingredients in Table 2 were mixed together using a mixer to form a secondary coating composition. Each strand was then passed through a 0.050 inch die to remove excess coating composition from the strand. Each strand was then dried using a circulating air oven at 610° F. and wound using a conventional roving winder.

Coated fiber glass strands produced in the above manner performed well when co-extruded with polyvinyl chloride at 550 feet per minute to produce drop wire cable. These coated fiber glass strands also passed the static load test (found in Standard GR-1069 from Telcordia Technologies). The co-extruded PVC and fiber glass strands did not exhibit any unusual blistering or breakout problems.

### EXAMPLE 3

In this example, the fiber glass strand was again HYBON 2026 roving having a nominal filament diameter of thirteen microns. This strand was provided to a secondary coating process.

The fiber glass strands were paid out through tensioners and dipped in a secondary coating composition using techniques known to those of ordinary skill in the art. The secondary coating composition that was used is set forth in Table 3 below:

TABLE 3

| | Amount | % of |
|---|---|---|
| Component | (parts by weight) | solids |
| AQUATHANE D516⁶ | 450 lbs. | 91.1% |
| PETROLITE 75⁷ | 32 lbs. | 3% |
| WITCOBOND XW⁸ | 22 lbs. | 5.9% |
| Water | 725 lbs. | 0% |

⁶Polyurethane dispersion from Reichhold Chemical Company.
⁷Functionalized polyethylene wax from Baker Petrolite, Polymer Division, of Cumming, Ga.
⁸Epoxy crosslinker from Crompton Corporation-Uniroyal Chemical.

The ingredients in Table 3 were mixed together using a mixer to form a secondary coating composition. Each strand was then passed through a 0.050 inch die to remove excess coating composition from the strand. Each strand was then dried using a circulating air oven at 610° F and wound using a conventional roving winder.

Coated fiber glass strands produced in the above manner performed well when co-extruded with polyvinyl chloride at 500 feet per minute to produce drop wire cable. These coated fiber glass strands also passed the static load test in found in Standard GR-1069 from Telcordia Technologies. The co-extruded PVC and fiber glass strands did not exhibit any unusual blistering or breakout problems.

Desirable characteristics, which can be exhibited by embodiments of the present invention, can include, but are not limited to, the provision of secondary coating compositions that can tolerate higher drying temperatures; the provision of fiber glass strands coated with a secondary coating composition that can be co-extruded in a drop wire cable manufacturing process at a higher line speed; the provision of fiber glass strands coated with a secondary coating that will pay out more consistently resulting in fewer breakouts due to excessive tack; the provision of fiber glass strands coated with a secondary coating that can be co-extruded in a drop wire cable manufacturing process without increased blistering; the provision of fiber glass strands coated with a secondary coating that adhere adequately when co-extruded with polyvinyl chloride in drop wire cable applications; and the ability to produce drop wire cables reinforced with fiber glass at higher line speeds.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

That which is claimed:

1. A secondary coating composition for at least partially coating glass fibers, comprising:
a polyurethane in an amount greater than about 85 weight percent of the secondary coating composition based on total solids; and
a wax.

2. The secondary coating composition of claim 1, wherein the polyurethane comprises a thermally stable polyurethane.

3. The secondary coating composition of claim 1, wherein the polyurethane does not degrade until temperatures of 220° C. or greater after one minute in an air environment.

4. The secondary coating composition of claim 1, wherein the polyurethane is substantially free of unreacted hydroscopic polyol segments.

5. The secondary coating composition of claim 1, wherein the polyurethane is substantially free of unreacted hydrophilic polyol segments.

6. The secondary coating composition of claim 1, wherein the polyurethane is present in an amount greater than about 90 weight percent of the secondary coating composition based on total solids.

7. The secondary coating composition of claim 1, wherein the wax comprises polyethylene.

8. The secondary coating composition of claim 1, wherein the wax comprises polypropylene.

9. The secondary coating composition of claim 1, wherein the wax is present in an amount up to about 15 weight percent of the secondary coating composition based on total solids.

10. The secondary coating composition of claim 1, wherein the wax is present in an amount up to about 10 weight percent of the secondary coating composition based on total solids.

11. The secondary coating composition of claim 1, wherein the wax is present in an amount up to about 8 weight percent of the secondary coating composition based on total solids.

12. The secondary coating composition of claim 1, further comprising a cross-linking agent.

13. The secondary coating composition of claim 12, wherein the cross-linking agent comprises an acid, an amine, or an epoxy.

14. The secondary coating composition of claim 12, wherein the cross-linking agent comprises an epoxy.

15. The secondary coating composition of claim 12, wherein the cross-linking agent is present in amount up to about 5 weight percent of the secondary coating composition based on total solids.

16. The secondary coating composition of claim 12 wherein the cross-linking agent is present in an amount up to about 2 weight percent of the secondary coating composition based on total solids.

17. A glass fiber at least partially coated with the residue of the secondary coating composition of claim 1.

18. A plurality of glass fibers comprising at least one glass fiber of claim 17.

19. The plurality of glass fibers of claim 18, wherein the glass fibers have a loss on ignition of up to twenty weight percent.

20. The plurality of glass fibers of claim 18, wherein the glass fibers have a loss on ignition of between about three and about fifteen weight percent.

21. The plurality of glass fibers of claim 18, wherein the glass fibers have a loss on ignition of between about nine and about eleven and one-half weight percent.

22. A cable assembly, comprising:
a conductor;
a protective layer positioned about at least a portion of a periphery of the conductor; and
glass fibers at least partially coated with the residue of the secondary coating composition of claim 1.

23. The cable assembly of claim 22, wherein the protective layer comprises polyvinyl chloride.

24. A secondary coating composition for at least partially coating glass fibers, the major constituents including:
a polyurethane in an amount greater than about 85 weight percent of the secondary coating composition based on total solids; and
a wax.

25. The secondary coating composition of claim 24, wherein the polyurethane comprises a thermally stable polyurethane.

26. The secondary coating composition of claim 24, wherein the polyurethane does not degrade until temperatures of 220° C. or greater after one minute in an air environment.

27. The secondary coating composition of claim 24, wherein the polyurethane is substantially free of unreacted hydroscopic polyol segments.

28. The secondary coating composition of claim 24, wherein the polyurethane is substantially free of unreacted hydrophilic polyol segments.

29. The secondary coating composition of claim 24, wherein the polyurethane is present in an amount greater than about 90 weight percent of the secondary coating composition based on total solids.

30. The secondary coating composition of claim 24, wherein the wax comprises polyethylene.

31. The secondary coating composition of claim 24, wherein the wax comprises polypropylene.

32. The secondary coating composition of claim 24, wherein the wax is present in an amount up to about 15 weight percent of the secondary coating composition based on total solids.

33. The secondary coating composition of claim 24, wherein the wax is present in an amount up to about 10 weight percent of the secondary coating composition based on total solids.

34. The secondary coating composition of claim 24, wherein the wax is present in an amount up to about 8 weight percent of the secondary coating composition based on total solids.

35. A glass fiber at least partially coated with the residue of the secondary coating composition of claim 24.

36. A plurality of glass fibers comprising at least one glass fiber of claim 35.

37. The plurality of glass fibers of claim 36, wherein the glass fibers have a loss on ignition of up to twenty weight percent.

38. The plurality of glass fibers of claim 36, wherein the glass fibers have a loss on ignition of between about three and about fifteen weight percent.

39. The plurality of glass fibers of claim 36, wherein the glass fibers have a loss on ignition of between about nine and about eleven and one-half weight percent.

40. A cable assembly, comprising:
a conductor;
a protective layer positioned about at least a portion of a periphery of the conductor; and
glass fibers at least partially coated with the residue of the secondary coating composition of claim 24.

41. The cable assembly of claim 40, wherein the protective layer comprises polyvinyl chloride.

42. A secondary coating composition for at least partially coating glass fibers, the major constituents including:
a polyurethane in an amount greater than about 85 weight percent of the secondary coating composition based on total solids;
a wax; and
a cross-linking agent.

43. The secondary coating composition of claim 42, wherein the polyurethane comprises a thermally stable polyurethane.

44. The secondary coating composition of claim 42, wherein the polyurethane does not degrade until temperatures of 220° C. or greater after one minute in an air environment.

45. The secondary coating composition of claim 42, wherein the polyurethane is substantially free of unreacted hydroscopic polyol segments.

46. The secondary coating composition of claim 42, wherein the polyurethane is substantially free of unreacted hydrophilic polyol segments.

47. The secondary coating composition of claim 42, wherein the polyurethane is present in an amount greater than about 90 weight percent of the secondary coating composition based on total solids.

48. The secondary coating composition of claim 42, wherein the wax comprises polyethylene.

49. The secondary coating composition of claim 42, wherein the wax comprises polypropylene.

50. The secondary coating composition of claim 42, wherein the wax is present in an amount up to about 15 weight percent of the secondary coating composition based on total solids.

51. The secondary coating composition of claim 42, wherein the wax is present in an amount up to about 10 weight percent of the secondary coating composition based on total solids.

52. The secondary coating composition of claim 42, wherein the wax is present in an amount up to about 8 weight percent of the secondary coating composition based on total solids.

53. The secondary coating composition of claim 42, wherein the cross-linking agent comprises an acid, an amine, or an epoxy.

54. The secondary coating composition of claim 42, wherein the cross-linking agent comprises an epoxy.

55. The secondary coating composition of claim 42, wherein the cross-linking agent is present in an amount up to about 5 weight percent of the secondary coating composition based on total solids.

56. The secondary coating composition of claim 42, wherein the cross-linking agent is present in an amount up to about 2 weight percent of the secondary coating composition based on total solids.

57. A glass fiber at least partially coated with the residue of the secondary coating composition of claim 42.

58. A plurality of glass fibers comprising at least one glass fiber of claim 57.

59. The plurality of glass fibers of claim 58, wherein the glass fibers have a loss on ignition of up to twenty weight percent.

60. The plurality of glass fibers of claim 58, wherein the glass fibers have a loss on ignition of between about three and about fifteen weight percent.

61. The plurality of glass fibers of claim 58, wherein the glass fibers have a loss on ignition of between about nine and about eleven and one-half weight percent.

62. A cable assembly, comprising:
a conductor;
a protective layer positioned about at least a portion of a periphery of the conductor; and
glass fibers at least partially coated with the residue of the secondary coating composition of claim 42.

63. The cable assembly of claim 62, wherein the protective layer comprises polyvinyl chloride.

64. A fiber glass strand adapted to exhibit reduced blistering and fewer breakouts during co-extrusion, comprising at least one glass fiber at least partially coated with a secondary coating composition, the major constituents including:
a polyurethane in an amount greater than about 85 weight percent on a total solids basis; and
a wax.

65. A cable assembly comprising at least one fiber glass strand according to claim 64.

66. A fiber glass strand adapted to exhibit reduced blistering and fewer breakouts during co-extrusion, comprising at least one glass fiber at least partially coated with a secondary coating composition, the major constituents including:
a polyurethane in an amount greater than about 85 weight percent on a total solids basis;
a wax; and
a cross linker.

67. A cable assembly comprising at least one fiber glass strand according to claim 66.
